(19) United States
(12) Patent Application Publication
(10) Pub. No.: US 2021/0358465 A1
(43) Pub. Date: Nov. 18, 2021

(54) DISPLAY PANEL AND DISPLAY DEVICE

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN)

(72) Inventors: Gu YAO, Beijing (CN); Tingyuan DUAN, Beijing (CN); Hu XIE, Beijing (CN)

(21) Appl. No.: 16/332,693

(22) PCT Filed: Oct. 8, 2018
(86) PCT No.: PCT/CN2018/109295

§ 371 Date: Mar. 12, 2019

(30) Foreign Application Priority Data
Jan. 15, 2018 (CN) 201810038446.1

(51) Int. Cl. G10K 9/128; H04R 15/00; G06F 1/16

(52) U.S. Cl. CPC G10K 9/128; H04R 2499/15; G06F 1/1605; H04R 15/00

(57) ABSTRACT

The present application discloses a display panel and a display device including the display panel. The display panel includes a display panel body, a magnet structure and a drive membrane. The drive membrane is located on the display panel body, and the magnet structure is located on a side of the drive membrane facing away from the display panel body. One or more conductive traces are arranged within the drive membrane, and the magnet structure is configured for generating a magnetic field. The drive membrane is configured to deform under an interaction between the magnetic field and a modulation current applied onto the one or more conductive traces, thereby driving the display panel body to vibrate and produce sounds.

### CROSS REFERENCE TO RELATED APPLICATION(S)

The present application claims the priority of the Chinese patent application No. 201810038446.1 filed on Jan. 15, 2018, the entire disclosure of which is incorporated herein by reference.

### TECHNICAL FIELD

The present disclosure generally relates to the technical field of audio-visual devices, and specifically to a display panel and a display device comprising the display panel, both of which are in particular adapted for use in an audio-visual device.

### BACKGROUND ART

In traditional audio-visual devices, most sound-producing devices are composed of loudspeakers. However, using loudspeakers as a sound-producing device is unfavorable to the development trend of audio-visual devices towards miniaturization and thinness.

### SUMMARY

According to an aspect of the present disclosure, a display panel is provided. The display panel comprises: a display panel body; a drive membrane on the display panel body, one or more conductive traces being provided within the drive membrane; and a magnet structure on a side of the drive membrane facing away from the display panel body, the magnet structure being configured for generating a magnetic field. Specifically, the drive membrane is configured to deform under an interaction between the magnetic field and a modulation current applied onto the one or more conductive traces, thereby driving the display panel body to vibrate and produce sounds.

According to a specific implementation, in an embodiment of the present disclosure, the display panel further comprises: an interlayer between the drive membrane and the magnet structure.

According to a specific implementation, in the display panel provided by an embodiment of the present disclosure, the interlayer further comprises an elastic structure.

According to a specific implementation, in the display panel provided by an embodiment of the present disclosure, the display panel body is made of a flexible material.

According to a specific implementation, in the display panel provided by an embodiment of the present disclosure, the magnet structure comprises a plurality of magnet units in a Halbach array.

According to a specific implementation, in the display panel provided by an embodiment of the present disclosure, the plurality of magnet units are evenly distributed in the magnet structure and configured to generate a one-sided magnetic field at a side of the magnet structure facing the drive membrane, wherein the one-sided magnetic field comprises one or more sub-magnetic fields, and an extension direction of each conductive trace is perpendicular to a magnetic line of force of a corresponding sub-magnetic field.

According to a specific implementation, in the display panel provided by an embodiment of the present disclosure, the plurality of magnet units are distributed at a perimeter of the magnet structure and configured to generate a magnetic field in a central part of the magnet structure, wherein the magnetic field comprises one or more sub-magnetic fields, and an extension direction of each conductive trace is perpendicular to a magnetic line of force of a corresponding sub-magnetic field.

According to a specific implementation, in the display panel provided by an embodiment of the present disclosure, the display panel, the drive membrane and the conductive traces are all made of a transparent material.

According to a specific implementation, in the display panel provided by an embodiment of the present disclosure, the display panel has a thickness smaller than or equal to 1 mm.

According to a specific implementation, in the display panel provided by an embodiment of the present disclosure, the drive membrane has a thickness smaller than or equal to 0.5 mm.

According to another aspect of the present disclosure, a display device is further provided. The display device comprises the display panel as described in any of the above embodiments.

### BRIEF DESCRIPTION OF DRAWINGS

By reading detailed depictions of the non-restrictive embodiments as made with reference to the drawings, other features, goals and advantages of the present application will be more obvious, wherein:

FIG. 1 schematically shows a side view of a display panel according to an embodiment of the present application;

FIG. 2 schematically shows a side view of a magnet structure in a display panel according to an embodiment of the present application;

FIG. 3 schematically shows a side view of a magnet structure in a display panel according to another embodiment of the present application;

FIG. 4 schematically shows a side view of a magnet structure in a display panel according to yet another embodiment of the present application;

FIG. 5 schematically shows a top view of conductive traces in a drive membrane for use with the magnet structure in FIG. 2;

FIG. 6 schematically shows a top view of an annular magnet structure in a display panel according to an embodiment of the present application;

FIG. 7 schematically shows a top view of an annular magnet structure in a display panel according to another embodiment of the present application;

FIG. 8 schematically shows a top view of an annular magnet structure in a display panel according to yet another embodiment of the present application;

and

FIG. 9 schematically shows a top view of conductive traces in a drive membrane for use with the annular magnet structure in FIG. 7.

### DETAILED DESCRIPTION OF EMBODIMENTS

The present application will be further explained in detail in combination with the drawings and the embodiments. It can be understood that the specific embodiments depicted herein are only used for explaining the present invention, instead of limiting the present invention. Besides, it should be further noted that in order to facilitate depictions, only portions related to the present invention are shown in the drawings.

It should be noted that embodiments in the present application and features of the embodiments can be combined with each other unless there is a conflict. The present application will be explained in detail with reference to the drawings and the embodiments.

Referring to FIG. 1, a side view of a display panel according to an embodiment of the present application is shown schematically. As shown in FIG. 1, the display panel comprises a display panel body 101, a magnet structure 103 and a drive membrane 102. Specifically, the drive membrane 102 is arranged on the display panel body 101, and the magnet structure 103 is arranged on a side of the drive membrane 102 facing away from the display panel body 101. The magnet structure 103 is used for generating a magnetic field, and one or more conductive traces are arranged within the drive membrane. When a modulation current is applied onto the one or more conductive traces, the one or more conductive traces will be subject to an Ampere force and thus deform because they are located in a magnetic field generated by the magnet structure 103, thereby driving the display panel body located nearby to vibrate and produce sounds.

As can be seen, in an embodiment of the present disclosure, the display panel body 101 can produce sounds by vibrations. In this case, when the display panel according to an embodiment of the present disclosure is used in an audio-visual device, there is no need anymore for arranging any speakers additionally in the audio-visual device, because the display panel body can serve as a sound-producing device by itself. Obviously, this will promote the development of audio-visual devices towards miniaturization and thinness.

In some embodiments, an interlayer 104 can be further formed between the drive membrane 102 and the magnet structure 103. Usually, the magnet structure 103 in use can be made of a rigid material. In this case, for the purpose of avoiding influences on the effect of sound production by vibration of the display panel body, a certain distance is finally maintained between the magnet structure 103 and the drive membrane 102. To this end, an interlayer 104 can be disposed between the drive membrane 102 and the magnet structure 103.

In some embodiments, the interlayer 104 between the magnet structure 103 and the drive membrane 102 can be formed by introducing an elastic structure 105. In this case, the elastic structure 105 made of an elastic material can serve as a connector between the magnet structure 103 and the drive membrane 102, which helps to actuate the display panel 101 to vibrate by means of deformation of the drive membrane 102. As an example, the elastic structure 105 can comprise a padding block or a padding strip made of an elastic material.

In some embodiments, the display panel body 101 can be made of a flexible material, so as to ensure a good vibration effect.

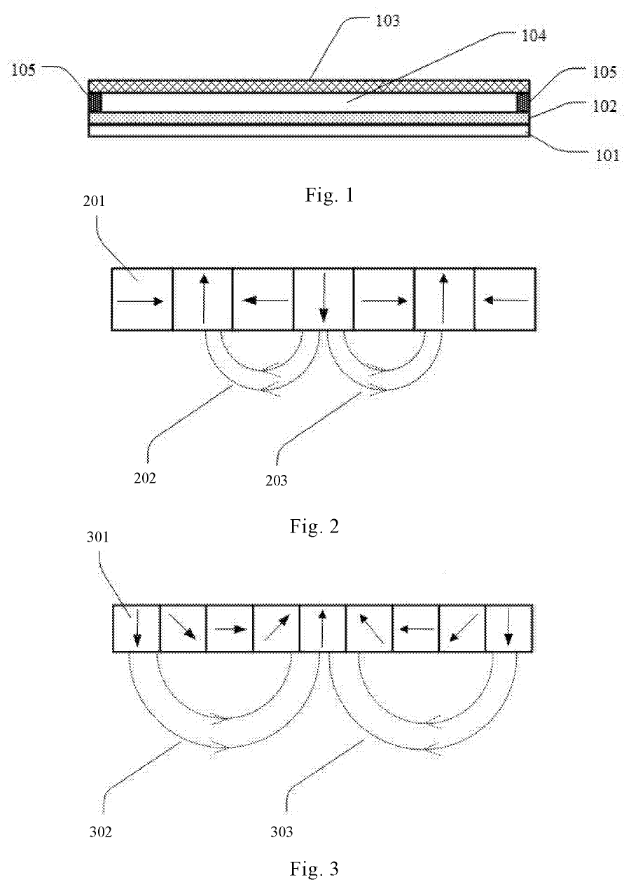

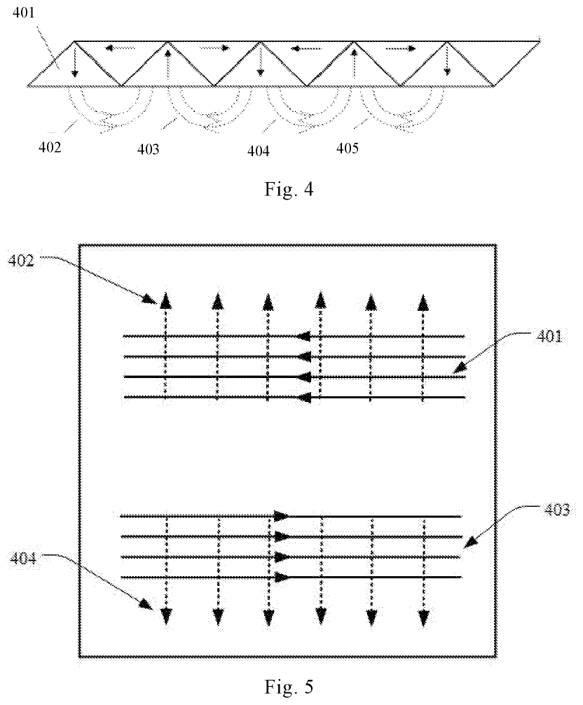

In some embodiments, the magnet structure 103 can comprise a plurality of magnet units, and the magnet units can be arranged in a Halbach array. The Halbach array that can be used in embodiments of the present disclosure will be illustrated with reference to FIGS. 2-4. Specifically, FIG. 2 schematically shows a side view of a magnet structure in a display panel according to an embodiment of the present application; FIG. 3 schematically shows a side view of a magnet structure in a display panel according to another embodiment of the present application; and FIG. 4 schematically shows a side view of a magnet structure in a display panel according to yet another embodiment of the present application.

Firstly, referring to FIGS. 2-4, side views of a magnet structure in a display panel according to embodiments of the present application are shown schematically. Specifically, the magnet structure shown in FIGS. 2-4 can comprise multiple rows or multiple columns of magnet units 201, wherein each row or column of magnet units 201 is arranged in a Halbach array. Using the arrangement of Halbach array, a one-sided magnetic field can be generated at a side of the magnet structure. Specifically, as shown in FIG. 2, in each row or each column, the block-shaped magnet units 201 are arranged periodically in a manner that the magnetic north pole thereof points towards right, top, left and bottom sequentially, thereby generating a one-sided sub-magnetic field 202 and a one-sided sub-magnetic field 203 as shown in FIG. 2. Alternatively, each row or each column of block-shaped magnet units 301 can also be arranged as shown in FIG. 3, i.e., arranged periodically in a manner that the magnetic north pole points towards bottom, bottom-right, right, top-right, top, top-left, left and bottom-left sequentially. Thereby, a one-sided sub-magnetic field 302 and a one-sided sub-magnetic field 303 with a sparse density will be generated. Further alternatively, the magnet units 401 can also be cone-shaped and arranged as shown in FIG. 4, i.e., be arranged periodically in a manner that the magnetic north pole points towards bottom, left, top and right sequentially. In this case, a one-sided sub-magnetic field 402, a one-sided sub-magnetic field 403, a one-sided sub-magnetic field 404 and a one-sided sub-magnetic field 405 with a dense density will be generated. It can be understood that the specific arrangement of a Halbach array in use can be selected upon actual scenes of application, and the present disclosure is not limited only to the situations listed above as examples. Returning to FIG. 1, when the magnet structure 103 is designed to take a form as shown in FIGS. 2-4, the magnetic field generated thereby will be located at a side of the magnet structure 103 facing the interlayer 104.

Next, referring to FIG. 5, a top view of conductive traces in a drive membrane for use with the magnet structure in FIG. 2 is shown schematically. As shown in FIG. 5, the drive membrane is provided with several conductive traces 401 and conductive traces 403, wherein an extension direction of the conductive traces 401 and the conductive traces 403 is perpendicular to a magnetic line of force of a corresponding one-sided sub-magnetic field, and the conductive traces 401 and the conductive traces 403 are applied with a modulation current. When energized, i.e., when a modulation current is applied, the conductive traces 401 and the conductive traces 403 will be subject to a force in the magnetic field generated by the magnet structure and thus deform (e.g., in a direction perpendicular to the panel), thereby actuating the display panel body to vibrate. The modulation current is usually provided by a modulation current source. The modulation current is characterized in that the current is adjustable, e.g., it is adjustable in terms of the current direction, the switching frequency of the current direction, the magnitude of the current and so on. The conductive traces can be made by using the following materials, but are not limited thereto. For example, they can be made of Ag, Mg, Indium Tin Oxide (ITO), Indium Zinc Oxide (IZO), Indium Gallium Zinc Oxide (IGZO) and so on.

In some embodiments, the magnet units are evenly distributed in the magnet structure, and thus a one-sided magnetic field is generated at a side of the magnet structure facing the drive membrane. Specifically, the one-sided magnetic field comprises several sub-magnetic fields, and an extension direction of each conductive trace is perpendicular to a magnetic line of force of a corresponding sub-magnetic field. Detailed depictions will be given with reference to FIGS. 2 and 5. In FIG. 5, the sub-magnetic field 402 and the sub-magnetic field 404 are respectively generated by the magnet structure in a Halbach array as shown in FIG. 2, and in the drive membrane, (i.e., in a region where the sub-magnetic field 402 and the sub-magnetic field 404 are distributed), several conductive traces 401 and conductive traces 403 are arranged. In this case, currents with different current directions are applied to the conductive traces 401 and the conductive traces 403, such that the directions of forces on the conductive traces 401 and the conductive traces 403 in the sub-magnetic field 402 and the sub-magnetic field 404 are maintained the same. In this way, vibrations of the display panel body can be actuated by means of the deformation of drive membrane. It can be understood that for the sub-magnetic fields in FIGS. 3 and 4, conductive traces perpendicular to their magnetic lines of force can also be arranged correspondingly in the drive membrane, thereby actuating vibrations of the display panel body. Besides, the conductive traces can also be designed to enclose a certain angle with the magnetic lines of force upon needs, and the present disclosure is not limited to the special situation where the conductive traces are perpendicular to the magnetic lines of force.

In some embodiments, the magnet units are distributed at a perimeter of the magnet structure, thereby generating a magnetic field in a central part of the magnet structure. In this case, the magnetic field can comprise several sub-magnetic fields, and an extension direction of each conductive trace is perpendicular to a magnetic line of force of a corresponding sub-magnetic field. As an example, in the current embodiment, the magnet units can be distributed at a perimeter of the magnet structure, thereby forming an annular magnet structure.

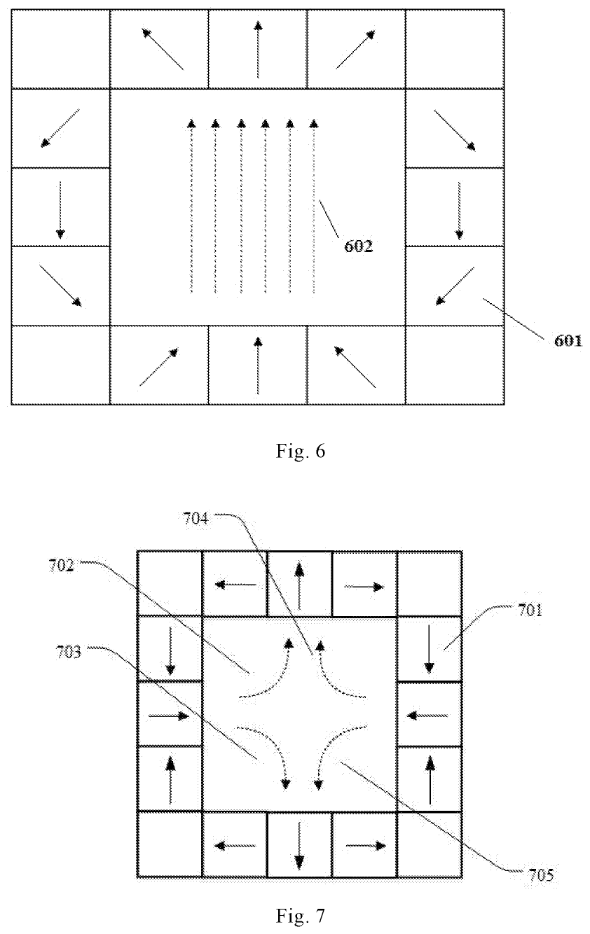

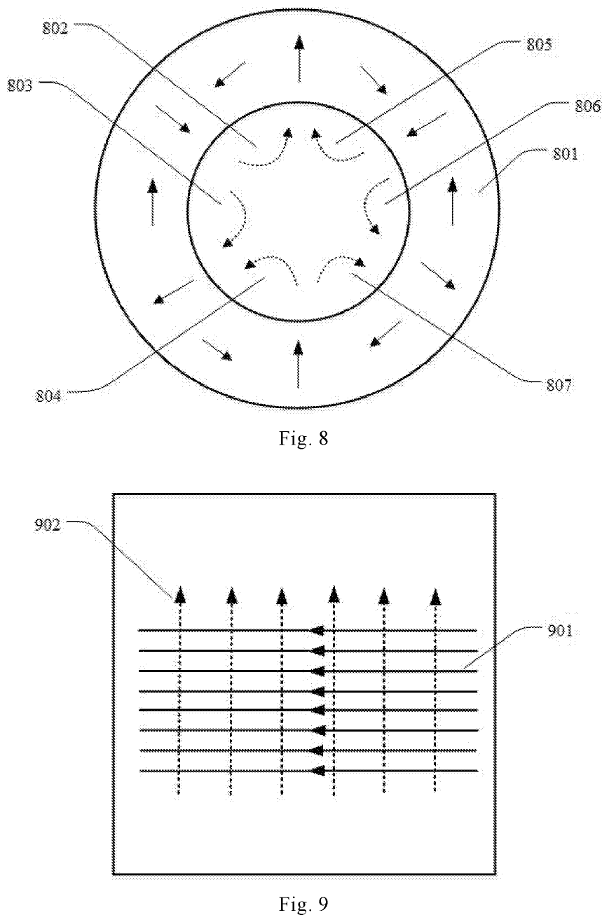

An annular magnet structure in the display panel according to an embodiment of the present disclosure will be explained in detail in combination with FIGS. 6-9. Specifically, FIG. 6 schematically shows a top view of an annular magnet structure in a display panel according to an embodiment of the present application; FIG. 7 schematically shows a top view of an annular magnet structure in a display panel according to another embodiment of the present application; FIG. 8 schematically shows a top view of an annular magnet structure in a display panel according to yet another embodiment of the present application; and FIG. 9 schematically shows a top view of conductive traces in a drive membrane for use with the annular magnet structure in FIG. 7.

As an example, the magnet units 601 can be arranged as shown in FIG. 6, thereby generating a unidirectional magnetic field 602 at center of the annular magnet structure. Alternatively, the magnet units 701 can also be arranged as shown in FIG. 7, thereby generating at center of the annular magnet structure sub-magnetic field 702, sub-magnetic field 703, sub-magnetic field 704 and sub-magnetic field 705 with four different directions. Further alternatively, the magnet units 801 can also be arranged as shown in FIG. 8, thereby generating at center of the annular magnet structure sub-magnetic field 802 to sub-magnetic field 807 with six different directions. It can be understood that the specific arrangement of a Halbach array in use can be selected upon actual scenes of application, and the present disclosure is not limited only to the structures listed above as examples.

Next, referring to FIG. 9, a top view of conductive traces in a drive membrane for use with the annular magnet structure in FIG. 6 is shown schematically. As shown in FIG. 9, the drive membrane is provided with several conductive traces 901, each being applied with a modulation current. When energized (i.e., when a modulation current is applied), the conductive traces 901 will be subject to a force in the magnetic field generated by the magnet structure and thus deform, thereby actuating the display panel body to vibrate. By the same token, with respect to the magnetic fields generated by the annular magnet structure in FIG. 7 and FIG. 8, different conductive traces perpendicular to each magnetic line of force can be arranged correspondingly based on the distribution of magnetic lines of force in the magnetic fields. In this way, forces with a same direction can be formed on the conductive traces, thereby actuating the display panel to vibrate and produce sounds. Besides, the conductive traces can also be designed to enclose a certain angle with the magnetic lines of force upon needs, and the present disclosure is not limited to the special situation where the conductive traces are perpendicular to the magnetic lines of force.

In some embodiments, the display panel, the drive membrane and the conductive traces are all made of a transparent material. When the display panel, the drive membrane and the conductive traces are all made of a transparent material, the magnet structure can be the annular magnet structure as shown in FIG. 6-FIG. 8. As a result, the conductive traces are subject to a force under the magnetic field generated at center of the magnet structure, thereby driving the display panel to vibrate.

In some embodiments, the display panel has a thickness smaller than or equal to 1 mm. In order to achieve a better effect of sound generation, the thickness of the display panel is preferably thin, for example, smaller than 1 mm. Suitable display panels include but are not limited to the following. For example, they can be an OLED display panel of a bottom-emission structure, an OLED display panel of a top-emission structure, a transparent Passive Matrix OLED (PMOLED) display panel or a transparent Active Matrix OLED (AMOLED) display panel.

In some embodiments, the drive membrane has a thickness smaller than or equal to 0.5 mm. Available materials of the drive membrane include but are not limited to the following. For example, they can be Polypropylene (PP), Polyethylene terephthalate (PET), polyvinyl chloride (PVC), Polycarbonate (PC), polyimide (PI) and so on.

The present invention further provides a display device. The display device comprises the display panel provided in any of the above embodiments.

Furthermore, in an embodiment of the present disclosure, when the display panel as described above is used to produce sounds in an audio-visual device, a current direction of the corresponding modulation current can be selected based on a direction of the magnetic lines of force in the magnetic field generated by the magnet structure, which ensures that the direction of force on each conductive trace is the same. Accordingly, it is guaranteed that the conductive traces and/or the drive membrane deform in the same direction, thereby actuating the display panel body to vibrate and produce sounds. Besides, a frequency and/or a magnitude of the sound produced can be adjusted by the following procedure. For example, by adjusting a switching frequency of the current direction of the modulation current, a switching frequency of the direction of force on the drive membrane in the magnetic field can be varied, and thus a vibration frequency of the display panel in the magnetic field can be varied and finally the frequency of sound produced can be adjusted. As another example, by adjusting a current magnitude of the modulation current, a magnitude of force on the drive membrane in the magnetic field can be varied, and thus a amplitude of vibration of the display panel in the magnetic field can be varied and the magnitude of sound produced can be adjusted.

As an example, in FIG. 2, when currents with indicated current directions are applied to respectively the conductive traces 401 and 403 in the sub-magnetic fields 402 and 403, directions of the forces on the conductive traces 401 and 403 will be the same such that the drive membrane deforms for the first time, thereby actuating the display panel to deform for the first time. After that, if directions of the modulation currents applied to the conductive traces 401 and 403 are adjusted to be opposite to those as shown in FIG. 2, directions of the forces on the conductive traces 401 and 403 will also be opposite to those as shown in FIG. 2. In this case, the drive membrane will deform for the second time in an opposite direction, thereby actuating the display panel to deform for the second time in an opposite direction. Likewise, by means of the subsequent driving of the drive membrane in two directions, the display panel will vibrate correspondingly. Besides, through variation in the switching frequency of the current direction of the conductive traces 401 and 403, the vibration frequency of the display panel can be varied such that the display panel body can produce sounds with different frequencies. Furthermore, through adjustment of the magnitude of currents applied to the conductive traces 401 and 403, the amplitude of vibration of the display panel can be adjusted and thus the magnitude of sound can be adjusted.

Flow charts and diagrams in the drawings only illustrate possible systematic architectures, functions and operations that can be implemented by the system, the method and the computer program product according to various embodiments of the present disclosure. In this regard, each box in the flow charts or the diagrams can represent a module, a program segment or a portion of codes, and the module, the program segment or the portion of codes comprises one or more executable instructions for implementing prescribed logic functions. It should be further noted that in some alternative implementations, the functions indicated in the boxes can also be performed in a sequence different from that indicated in the drawings. For example, two consecutive boxes can actually be executed substantially concurrently, and sometimes they can also be executed in an opposite sequence, which depends on the functions involved. Besides, it should be noted that each box in the diagrams and/or the flow charts, and a combination of the boxes in the diagrams and/or the flow charts can be implemented by means of a hardware-based system dedicated for executing the prescribed functions or operations, or by means of a combination of dedicated hardware and computer instructions.

What is described above is only preferred embodiments of the present application and explanations of the employed technical principles. Those skilled in the art should understand that the inventive scope of the present application is not limited by the technical solutions formed by a specific combination of the above technical features. Instead, it should also cover other technical solutions formed by a random combination of the above technical feature or equivalent features without deviating from the inventive concept. For example, the present application can comprise technical solutions formed by replacing the above features with technical features having similar functions as disclosed in the present application, but not limited thereto.

1. A display panel, comprising:
a display panel body;
a drive membrane on the display panel body, wherein the drive membrane comprises one or more conductive traces within the drive membrane; and
a magnet structure on a side of the drive membrane facing away from the display panel body,
wherein the magnet structure is configured to generate a magnetic field, and
wherein the drive membrane is configured to deform under an interaction between the magnetic field and a modulation current applied to the one or more conductive traces, thereby driving the display panel body to vibrate and produce sounds.

2. The display panel according to claim 1, further comprising:
an interlayer between the drive membrane and the magnet structure.

3. The display panel according to claim 2, wherein the interlayer comprises an elastic structure.

4. The display panel according to claim 2, wherein the display panel body comprises a flexible material.

5. The display panel according to claim 4, wherein the magnet structure comprises a plurality of magnet units in a Halbach array.

6. The display panel according to claim 5,
wherein the plurality of magnet units are evenly distributed in the magnet structure and configured to generate a one-sided magnetic field at a side of the magnet structure facing the drive membrane,
wherein the one-sided magnetic field comprises one or more sub-magnetic fields, and
wherein an extension direction of each of the one or more conductive traces is perpendicular to a magnetic line of force of a corresponding one of the sub-magnetic fields.

7. The display panel according to claim 5,
wherein the plurality of magnet units are distributed at a perimeter of the magnet structure and configured to generate a magnetic field in a central part of the magnet structure,
wherein the magnetic field comprises one or more sub-magnetic fields, and
wherein an extension direction of each of the one or more conductive traces is perpendicular to a magnetic line of force of a corresponding one of the sub-magnetic fields.

8. The display panel according to claim 7, wherein the display panel, the drive membrane and the conductive traces comprise a transparent material.

9. The display panel according to claim 1,
wherein the display panel has a thickness less than or equal to 1 mm.

10. The display panel according to claim 9,
wherein the drive membrane has a thickness less than or equal to 0.5 mm.

11. A display device, comprising the display panel according to claim 1.

12. The display device according to claim 10, wherein the display panel further comprises:
an interlayer between the drive membrane and the magnet structure.

13. The display device according to claim 12, wherein the interlayer comprises an elastic structure.

14. The display device according to claim 12, wherein the display panel body comprises a flexible material.

15. The display device according to claim 14, wherein the magnet structure comprises a plurality of magnet units in a Halbach array.

16. The display device according to claim 15,
wherein the plurality of magnet units are evenly distributed in the magnet structure and configured to generate a one-sided magnetic field at a side of the magnet structure facing the drive membrane,
wherein the one-sided magnetic field comprises one or more sub-magnetic fields, and
wherein an extension direction of each of the one or more conductive traces is perpendicular to a magnetic line of force of a corresponding one of the sub-magnetic fields.

17. The display device according to claim 15,
wherein the plurality of magnet units are distributed at a perimeter of the magnet structure and configured to generate a magnetic field in a central part of the magnet structure,
wherein the magnetic field comprises one or more sub-magnetic fields, and
wherein an extension direction of each of the one or more conductive traces is perpendicular to a magnetic line of force of a corresponding one of the sub-magnetic fields.

18. The display device according to claim 17, wherein the display panel, the drive membrane and the conductive traces comprise a transparent material.

19. The display device according to claim 10, wherein the display panel has a thickness less than or equal to 1 mm.

20. The display device according to claim 19, wherein the drive membrane has a thickness less than or equal to 0.5 mm.
